(19) United States
(12) Patent Application Publication
(10) Pub. No.: US 2023/0026245 A1
(43) Pub. Date: Jan. 26, 2023

(54) SYSTEM AND METHOD FOR IMPLEMENTING AND MANAGING A DISTRIBUTED DATA FLOW MODEL

(71) Applicant: Sayantek, Inc, San Jose, CA (US)

(72) Inventor: Murali Kumar Singamsetty, San Jose, CA (US)

(21) Appl. No.: 17/936,871

(22) Filed: Sep. 30, 2022

Related U.S. Application Data
(63) Continuation-in-part of application No. 17/095,783, filed on Nov. 12, 2020.

(51) Int. Cl. H04L 47/193; H04L 9/40

(52) U.S. Cl. CPC H04L 47/193; H04L 63/061

(57) ABSTRACT

A system and method for implementing and managing a distributed data flow model is disclosed. The method includes obtaining a flow configuration file and identifying one or more socket roles and a unique identification number. The method includes establishing a TCP connection of one or more runtime nodes with the one or more flow neighbors, establishing a publisher-subscriber relationship of the one or more runtime nodes with the one or more flow neighbors, and implementing one or more bridge wires with the one or more runtime nodes and the one or more flow neighbors. Furthermore, the method includes detecting a loss of connectivity of one or more networks, determining one or more root causes of the loss of connectivity, and perform one or more operations to attain a predefined level of resiliency of the distributed data flow model.

### CROSS-REFERENCE TO RELATED APPLICATIONS

This Application is a continuation in part of a non-provisional patent application filed in the US having patent application Ser. No. 17/095,783 filed on Nov. 12, 2020 and titled “SYSTEM AND METHOD FOR IMPLEMENTATION OF A DISTRIBUTED DATA FLOW-BASED FRAMEWORK”.

### FIELD OF INVENTION

Embodiments of the present disclosure relate to edge computing, distributed processing and flow-based programming and more particularly relate to a system and method for implementing and managing a distributed data flow model.

### BACKGROUND

Dataflow programming is a design paradigm used to architect complex software systems. The data flow programming utilizes a concept of dataflow which is a Directed Acyclic Graph (DAG) composed of ‘nodes’ and ‘wires’ A node within the context of dataflow is an asynchronous processing block that is executed when a message is presented at its input or by an event within the system. A wire, in its literal sense, is a strand of metal capable of transmitting power. However, in the context of a data flow, it is a construct that transmits messages from one node to another. Nodes generate one or more messages which are then fed to other processing blocks, i.e. nodes as determined by how the nodes are interconnected by the wires in the dataflow. Wires, on the other hand, connect node output ports to node input ports establishing how the nodes in the dataflow interact in the system in a sequential and event-driven manner. The objective of dataflow programming is to reduce or eliminate the global state in the system. Generally, the global state increases complexity and makes the system prone to instabilities due to state misuse and corruption. In this specification, the term ‘node’ refers to a dataflow construct, whereas ‘compute node’ refers to a physical device or virtual machine instance which provides persistent storage, networking, memory, and processing resources. A ‘runtime node’ is a compute node equipped with functionality, usually in software, to host and run one or more dataflows or a portion of a dataflow. Furthermore, a distributed data flow model is defined as one or more dataflows capable of spanning multiple runtime nodes wherein each participating runtime node runs one or more portions of a Directed Acyclic Graph (DAG) composed of ‘nodes’ and ‘wires’ independently. Furthermore, a ‘bridge wire’ is a wire in the distributed data flow model that crosses the compute node boundaries. Further, flow neighbors include two runtime nodes that have one or more bridge wires between the runtime nodes. Various methods have been utilized conventionally for implementing data flow systems for peer-to-peer distributed processing applications.

One such conventional method includes distributed data flow, its hub and spoke architecture in which participating compute nodes have a reliance on a centralized Message Queuing Telemetry Transport (MQTT) message broker for exchanging data. However, such a conventional method for implementing the dataflow system for large scale edge deployments requires a central broker at each of the edge sites in addition to a cloud or data-centre-based broker to interconnect these sites. Also, every compute node is connected to the central broker and requires an involvement of the central broker for communication with other compute nodes. Moreover, presence of the central broker increases latency and increases the overall system complexity. Furthermore, the presence of the central broker limits the scalability of the data flow system and increase the total cost of ownership of such system.

Further, several web-based platforms have emerged to ease the development of interactive or near-real-time Internet of Things (IoT) applications by providing a way to connect things and services together and process the data they emit using a data flow paradigm. The dataflow is built over Information Technology (IT) infrastructure and used to architect complex software systems. The distributed dataflow paradigm includes one or more constituents, wherein the one or more constituents do not guarantee fail-proof operation over extended periods. Various methods have been introduced to achieve an acceptable level of resiliency in order to reconnect peer-to-peer communicating compute nodes back into a Distributed Data Flow (DDF) system.

One of a conventional distributed data flow model includes one or more compute nodes connected within a network. However, such a conventional distributed data flow-based model includes the network which is congested and drops traffic, one or more compute nodes may fail, and battery-powered sensor nodes may purposefully sleep to conserve energy and so on. Regardless of such conditions, real-life systems should provide reasonable assurance of functioning in such conditions and the same applies to a DDF based system. Also, the conventional distributed data flow-based model does include one or more self-sufficient nodes which wake up at pre-determined time or event and should be able to participate in a DDF. However, the conventional distributed data flow-based model fails to detect and determine root causes of failures of such compute nodes. Moreover, such the distributed data flow-based model is unable to recover from link failures and temporary loss of connectivity of network and continue to be non-operational which leads to one or more losses.

Hence, there is a need for an improved system and method for implementing and managing a distributed data flow model, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computing system for implementing and managing a distributed data flow model is disclosed. The computing system includes one or more hardware processors and a memory coupled to the one or more hardware processors. The memory includes a plurality of modules in the form of programmable instructions executable by the one or more hardware processors. The plurality of modules include a data obtaining module configured to obtain a flow configuration file of a predefined format associated with one or more runtime nodes of a distributed data flow model from a controller. The flow configuration file includes a JavaScript Object Notation (JSON) file format comprising data flow configuration information. The data flow configuration information includes flow design of the one or more runtime nodes, one or more node configurations, one or more interconnecting wires, and one or more runtime node configurations. The one or more runtime nodes are one or more compute nodes equipped with a predetermined functionality for execution of a distributed data flow. The plurality of modules also include a bridge wire identification module configured to identify one or more socket roles and a unique identification number corresponding to each of the one or more flow neighbors based on the obtained flow configuration file. The plurality of modules includes a connection establishing module configured to establish a Transmission Control Protocol (TCP) connection of the one or more runtime nodes with each of one or more flow neighbors based on the identified one or more socket roles and the identified unique identification number. The TCP connection enables TCP keepalives for preventing deactivation of the established TCP connection, and

wherein a single TCP connection is established between each pair of flow neighbors from each of the one or more runtime nodes. Further, the connection establishing module is also configured to establish a publisher-subscriber relationship of the one or more runtime nodes with each of the one or more flow neighbors for forwarding flow messages based on the established TCP connection. The publisher-subscriber relationship includes a relationship between a peer-to-peer publisher on a message originating runtime node and a peer-to-peer subscriber on a message receiving runtime node. The connection establishing module is configured to implement one or more bridge wires with the one or more runtime nodes and the one or more flow neighbors for implementation of the distributed data flow model based on the established publisher-subscriber relationship. The plurality of modules also include a data failure detection module configured to detect a loss of connectivity of one or more networks, and an operational failure of one or more nodes and the one or more runtime nodes deployed in the distributed dataflow model based on implementation of the one or more bridge wires. The one or more nodes include one of: one or more compute nodes and one or more battery powered sensing nodes. Further, the plurality of modules include a cause determination module configured to determine one or more root causes of the detected loss of connectivity. The plurality of modules also include an operation performing module configured to perform one or more operations to attain a predefined level of resiliency of the distributed data flow model over the one or more bridge wires based on the detected loss of connectivity and the determined one or more root causes.

In accordance with another embodiment of the present disclosure, a method for implementing and managing a distributed data flow model is disclosed. The method includes obtaining a flow configuration file of a predefined format associated with one or more runtime nodes of a distributed data flow model from a controller. The flow configuration file includes a JSON file format including data flow configuration information. The data flow configuration information includes flow design of the one or more runtime nodes, one or more node configurations, one or more interconnecting wires, and one or more runtime node configurations. The one or more runtime nodes are one or more compute nodes equipped with a predetermined functionality for execution of a distributed data flow. The method further includes identifying one or more socket roles and a unique identification number corresponding to each of the one or more flow neighbors based on the obtained flow configuration file. Further, the method includes establishing a TCP connection of the one or more runtime nodes with each of one or more flow neighbors based on the identified one or more socket roles and the identified unique identification number. The TCP connection enables TCP keepalives for preventing deactivation of the established TCP connection. A single TCP connection is established between each pair of flow neighbors from each of the one or more runtime nodes. Also, the method includes establishing a publisher-subscriber relationship of the one or more runtime nodes with each of the one or more flow neighbors for forwarding flow messages based on the established TCP connection. The publisher-subscriber relationship includes a relationship between a peer-to-peer publisher on a message originating runtime node and a peer-to-peer subscriber on a message receiving runtime node. Furthermore, the method includes implementing one or more bridge wires with the one or more runtime nodes and the one or more flow neighbors for implementation of the distributed data flow model based on the established publisher-subscriber relationship. The method also includes detecting a loss of connectivity of one or more networks, and an operational failure of one or more nodes and the one or more runtime nodes deployed in the distributed dataflow model based on implementation of the one or more bridge wires. The one or more nodes include one of: one or more compute nodes and one or more battery powered sensing nodes. Further, the method includes determining one or more root causes of the detected loss of connectivity. The method includes performing one or more operations to attain a predefined level of resiliency of the distributed data flow model over the one or more bridge wires based on the detected loss of connectivity and the determined one or more root causes.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for implementing and managing a distributed data flow model, in accordance with an embodiment of the present disclosure;

FIG. 2 is a block diagram illustrating an exemplary computing system for implementing and managing the distributed data flow model, in accordance with an embodiment of the present disclosure;

FIG. 3 is a block diagram illustrating a controller for implementing the distributed data flow model, in accordance with an embodiment of the present disclosure;

FIG. 4 is a block diagram illustrating an exemplary private network scenario for implementing the distributed data flow model, in accordance with an embodiment of the present disclosure;

FIG. 5 is a block diagram illustrating an exemplary hybrid network scenario for implementing the distributed data flow model, in accordance with an embodiment of the present disclosure;

FIG. 6 is a block diagram illustrating exemplary hierarchies of three networks protected by firewalls for implementing the distributed data flow model, in accordance with an embodiment of the present disclosure;

FIG. 7 is a schematic representation depicting operation of the exemplary computing system for implementing and managing the distributed data flow model, in accordance with an embodiment of the present disclosure;

FIG. 8 is a schematic representation depicting operation of the exemplary computing system for implementing and managing the distributed data flow model, in accordance with another embodiment of the present disclosure; and

FIG. 9 is a process flow diagram illustrating an exemplary AI-based method for implementing and managing the distributed data flow model, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

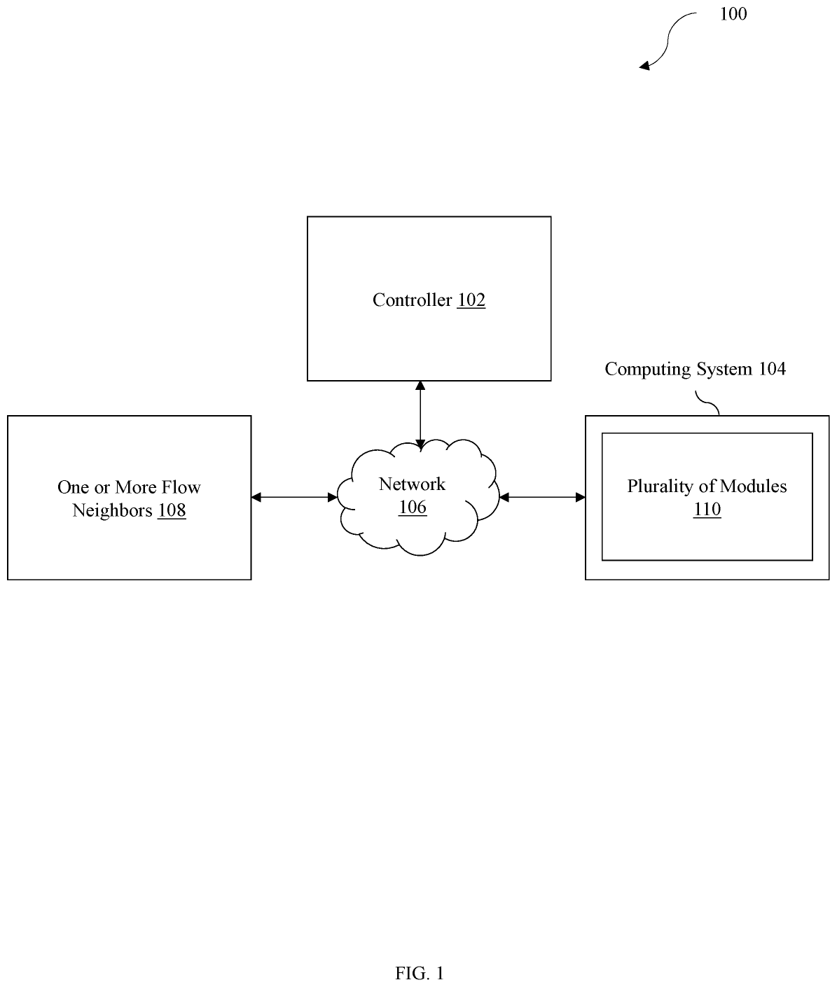

Referring now to the drawings, and more particularly to FIG. 1 through FIG. 9, where similar reference characters denote corresponding features consistently throughout the figures, there are shown preferred embodiments and these embodiments are described in the context of the following exemplary system and/or method.

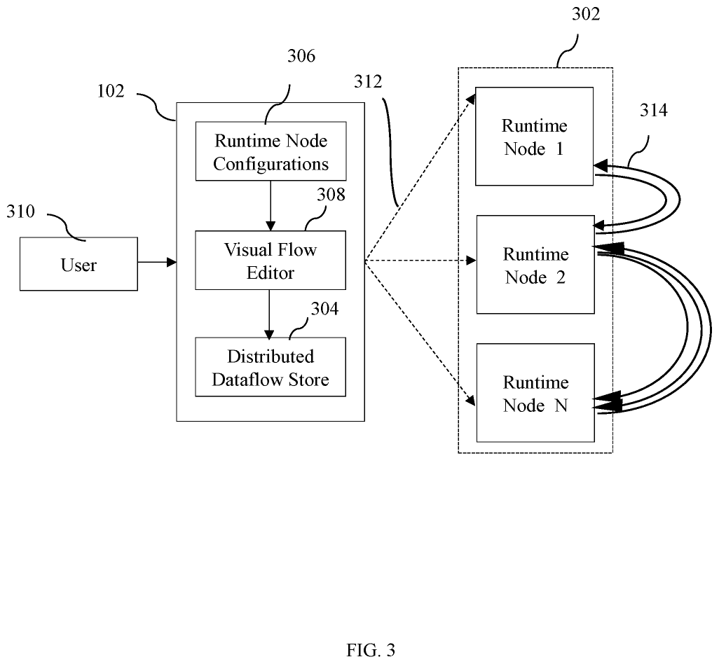

FIG. 1 is a block diagram illustrating an exemplary computing environment 100 for implementing and managing a distributed data flow model, in accordance with an embodiment of the present disclosure. According to FIG. 1, the computing environment 100 includes a controller 102 communicatively coupled to a computing system 104 via a network 106. In an embodiment of the present disclosure, the controller 102 is a centralized management entity. Details on the controller 102 have been elaborated in subsequent paragraphs of the present description with reference to FIG. 3. In an embodiment of the present disclosure, the computing system 104 may correspond to a runtime node. As used herein, the term ‘runtime node’ is defined as a compute node equipped with the necessary functionality, usually implemented in software, to process a flow. Further, the network 106 may be internet or any other wireless network.

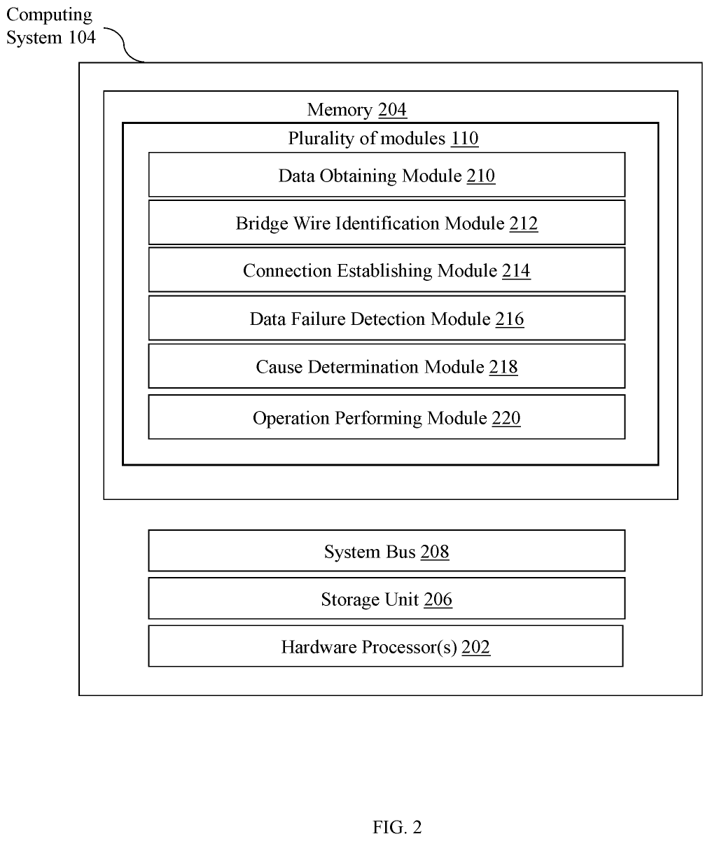

Further, the computing environment 100 includes one or more flow neighbors communicatively coupled to the computing system 104 via the network 106. For example, the one or more flow neighbors includes two runtime nodes that have one or more bridge wires between the two runtime nodes. In an embodiment of the present disclosure, the one or more bridge wires are defined as a wire in a flow that crosses runtime node boundaries. Furthermore, the computing system 104 includes a plurality of modules 110. Details on the plurality of modules 110 have been elaborated in subsequent paragraphs of the present description with reference to FIG. 2.

In an embodiment of the present disclosure, the computing system 104 is configured to obtain a flow configuration file of a predefined format associated with one or more runtime nodes of a distributed data flow model from a controller 102. The one or more runtime nodes are one or more compute nodes equipped with a predetermined functionality for execution of a distributed data flow. The computing system 104 identifies one or more socket roles and a unique identification number corresponding to each of one or more flow neighbors based on the obtained flow configuration file. The computing system 104 establishes a Transmission Control Protocol (TCP) connection of the one or more runtime nodes with each of the one or more flow neighbors based on the identified one or more socket roles and the identified unique identification number. Furthermore, the computing system 104 establishes a publisher-subscriber relationship of the one or more runtime nodes with each of the one or more flow neighbors for forwarding flow messages based on the established TCP connection. The computing system 104 implements one or more bridge wires with the one or more runtime nodes and the one or more flow neighbors for implementation of the distributed data flow model based on the established publisher-subscriber relationship. The computing system 104 detects a loss of connectivity of one or more networks, and an operational failure of one or more nodes and the one or more runtime nodes deployed in the distributed dataflow model based on implementation of the one or more bridge wires. Further, the computing system 104 determines one or more root causes of the detected loss of connectivity. The computing system 104 performs one or more operations to attain a predefined level of resiliency of the distributed data flow model over the one or more bridge wires based on the detected loss of connectivity and the determined one or more root causes.

FIG. 2 is a block diagram illustrating an exemplary computing system 104 for implementing and managing a distributed data flow model. Further, the computing system 104 includes one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 110 in the form of programmable instructions executable by the one or more hardware processors 202. Further, the plurality of modules 110 includes a data obtaining module 210, a bridge wire identification module 212, a connection establishing module 214, a data failure detection module 216, a cause determination module 218, and an operation performing module 220.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 110 stored in the form of machine-readable instructions on any of the above-mentioned storage media and may be in communication with and executed by the one or more hardware processors 202.

In an embodiment of the present disclosure, the storage unit 206 may be a local storage or cloud storage. The storage unit 206 may store a flow configuration file, one or more socket roles and a unique identification number corresponding to each of one or more flow neighbors, one or more root causes of a detected loss of connectivity, one or more operations to attain a predefined level of resiliency of the distributed data flow model, distributed data flow details, data flow configuration information of the one or more runtime nodes, one or more portions of the distributed data flow network, publisher-subscriber service information for each of the identified one or more flow neighbors, and the like.

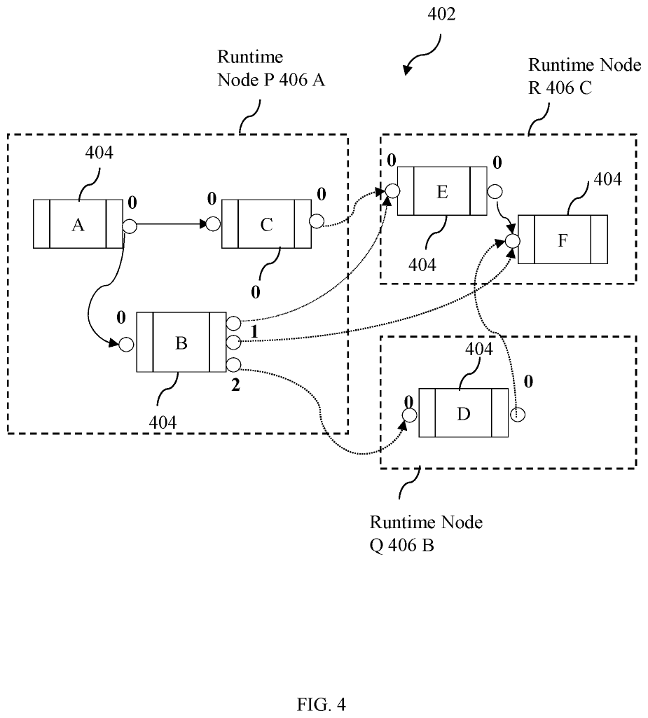

The data obtaining module 210 is configured to obtain the flow configuration file of a predefined format associated with the one or more runtime nodes of the distributed data flow model from the controller 102. In an embodiment of the present disclosure, the distributed data flow model is defined as one dataflow capable of running a portion of a Directed Acyclic Graph (DAG) composed of ‘nodes’ and ‘wires’ independently. The term ‘distributed data flow’ is defined as a dataflow that spans runtime nodes. Each runtime node executes a portion of distributed flow when successfully deployed. Further, the distributed dataflow mode may include a dataflow model distributed over the one or more runtime nodes. The flow configuration file includes a JavaScript Object Notation (JSON) file format including data flow configuration information. In an exemplary embodiment of the present disclosure, the data flow configuration information includes flow design of the one or more runtime nodes, one or more node configurations, one or more interconnecting wires, one or more runtime node configurations, and the like. FIG. 4 shows an example of a distributed data flow design. The user draws a data flow diagram via a visual editor by picking up node A through F from a palette and wires them up. In the below example of flow configuration file, Node A has its configuration parameters included. It has interval at 60 seconds and sensor port specified as 2. In such embodiment, the one or more runtime node configurations may include, but not limited to, port numbers, Internet Protocol (IP) address, public key information of the public-key cryptography and the like. In an embodiment of the present disclosure, the port numbers may include pre-determined port numbers for publisher and subscriber services with listening socket role. The one or more runtime nodes are one or more compute nodes equipped with a predetermined functionality for execution of a distributed data flow. In an embodiment of the present disclosure, the computing runtime node is defined as a node which provides storage, networking, memory, and processing resources that is used by virtual machine instances. For example, the predefined format of the one or more runtime nodes in JSON is:

```
“RuntimeNodes”: [{
    “name”:”P”,
    “ip”: “192.168.1.23”,
    “publicKey” : “kjfjfkrejr748579”
  }, ..]
  “Nodes”: [{
        “id”:”578795”,
        ″runtime: ″P″,
        “name”:”A”,
        “interval”: “60”,
        “sensor_port”: “2”,
        “wires”: [
          “A0-C0”,
          “A0-B0”
        ]
      }...]
```

In an embodiment of the present disclosure, the controller 102 is configured to obtain distributed data flow details from a user. In an exemplary embodiment of the present disclosure, the distributed data flow details include a design of the distributed data flow model. The controller 102 registers the one or more runtime nodes of the distributed data flow model based on the obtained distributed data flow details from the user. In an embodiment of the present disclosure, the distributed data flow model includes a dataflow model distributed over the one or more runtime nodes. Further, the controller 102 receives the data flow configuration information of the one or more runtime nodes from each of the one or more runtime nodes upon successful registration of the one or more runtime nodes. The controller 102 generates the flow configuration file of the predefined format for the one or more runtime nodes upon the successful registration. In an embodiment of the present disclosure, the user designs a distributed data flow using visual flow editor of the controller. The controller converts the design into flow configuration file for distribution to the runtime nodes that are used in the design of the distributed data flow. In an embodiment of the present disclosure, the one or more runtime nodes are one or more edge computing runtime nodes.

The bridge wire identification module 212 is configured to identify the one or more socket roles and the unique identification number corresponding to each of one or more flow neighbors based on the obtained flow configuration file. In identifying the one or more socket roles and the unique identification number corresponding to each of the one or more flow neighbors based on the obtained flow configuration file upon determining the publisher and the subscriber service information, the bridge wire identification module 212 identifies one or more portions of the distributed data flow network based on the obtained flow configuration file. Referring to the FIGS. 4, 406 A, 406 B and 406 C are the rectangular boxes that user draws over data flow in the visual designer, creating portions or partitions of the dataflow. Each box has a label that refers to one or group of runtime nodes that need to deploy the portion contained within the rectangle. 406A portion may be deployed on Runtime Node A, 406B on Q and 406C on R. These partitions are also part of the flow configuration file. In the example above, the runtime config file has runtime node assignment of ‘P’ in Node A's configuration. Further, the bridge wire identification module 212 deploys one or more nodes and one or more interconnecting wires on the one or more runtime nodes based on the identified one or more portions of one or more distributed dataflows. As used herein, the term ‘nodes’ are defined as processing blocks in flow-based programming paradigm. In an embodiment of the present disclosure, the processing blocks or processors, as used herein, means any type of computational circuit, such as, but not limited to, a microprocessor, a microcontroller, a complex instruction set computing microprocessor, a reduced instruction set computing microprocessor, software routine or a function in the list, a very long instruction word microprocessor, an explicitly parallel instruction computing microprocessor, a digital signal processor, or any other type of processing circuit, or a combination thereof. Furthermore, the one or more nodes include one or more input ports and one or more output ports. In an embodiment of the present disclosure, the one or more interconnecting wires correspond to flow of messages from an output port of a node to an input port of another node. In an embodiment of the present disclosure, the one or more flow messages over interconnecting wires are represented internally as JSON objects with necessary and sufficient contract to support functionality and connectivity of the one or more nodes. The bridge wire identification module 212 extracts the data flow configuration information from the flow configuration file for deploying the one or more nodes and the one or more interconnecting wires. Further, the bridge wire identification module 212 identifies the one or more flow neighbors associated with each of the one or more runtime nodes based on the extracted data flow configuration information. In an embodiment of the present disclosure, the one or more flow neighbors include two runtime nodes that have one or more bridge wires between the two runtime nodes. In an embodiment of the present disclosure, the one or more bridge wires are defined as a wire in a flow that crosses runtime node boundaries. Furthermore, the bridge wire identification module 212 determines publisher-subscriber service information for each of the identified one or more flow neighbors based on the extracted data flow configuration information. As used herein, the term ‘publisher’ is defined as an entity responsible for posting messages to a topic. Similarly, the term ‘subscriber’ is defined as an application which registers itself with a desired topic to receive the appropriate messages. The term ‘topic’ is defined as an intermediary channel that maintains a list of subscribers to relay messages to that are received from publishers. In an exemplary embodiment of the present disclosure, the publisher-subscriber service information includes registration information of the peer-to-peer publisher and the peer-to-peer subscriber with a unique topic between the one or more runtime nodes and the one or more flow neighbors. In an embodiment of the present disclosure, the peer-to-peer publisher and the peer-to-peer subscriber register to a topic that is unique (between flow neighbors) and derived from bridge wire details. For example, topic string ‘C0-E0’ uniquely identifies the bridge wire in the DDF that connects output port 0 of node C to input port 0 of node E. For example, a unique topic for each bridge wire is derived from details of input and output nodes connected by the bridge wire. The bridge wire identification module 212 identifies the one or more socket roles and the unique identification number corresponding to each of the one or more flow neighbors based on the obtained flow configuration file upon determining the publisher and the subscriber service information. Each runtime node has a unique name within the system of DDF of the present embodiment. This name is assigned during installation & setup of the runtime by the administrator. By simply converting the characters of the unique name into alphanumeric numbers and concatenating them will give us unique number. Derivation of unique number from unique name is necessary for comparing UIDs of runtimes to determine socket roles. In an exemplary embodiment of the present disclosure, the one or more socket rules comprise an initiate socket role, an accept socket role, or a combination thereof. In an embodiment of the present disclosure, publisher-subscriber models with the publisher-subscriber relationship solve the problem of ‘one to many’ and ‘many to one’ connections needed for the distributed data flow-based model.

The connection establishing module 214 is configured to establish the Transmission Control Protocol (TCP) connection of the one or more runtime nodes with each of the one or more flow neighbors based on the identified one or more socket roles and the identified unique identification number. The TCP connection enables TCP keepalives for preventing deactivation of the established TCP connection. In an embodiment of the present disclosure, a single TCP connection is established between each pair of flow neighbors from each of the one or more runtime nodes. In an embodiment of the present disclosure, the TCP connection may be secure or insecure depending on the deployment environment. A dedicated TCP connection is not created for each bridge wire instead a single TCP connection is established between each pair of flow neighbours from each of the one or more runtime nodes. In some cases, certain publisher/subscriber implementations may not allow sharing of a single TCP connection by both the publisher and the subscriber service. In such cases, a pair of TCP connections may be necessary to support one or more bridge wires in both directions. Since the performance and memory consumption of runtime depends on the number of TCP connections, this approach improves scalability as the number of TCP connections increases linearly with the number of runtimes instead of the number of bridge wires in the distributed data flow model.

Further, the connection establishing module 214 is configured to establish the publisher-subscriber relationship of the one or more runtime nodes with each of the one or more flow neighbors for forwarding flow messages based on the established TCP connection. In an embodiment of the present disclosure, the publisher-subscriber relationship includes a relationship between a peer-to-peer publisher on a message originating runtime node and a peer-to-peer subscriber on a message receiving runtime node. In an embodiment of the present disclosure, the distributed data flow model deployed entirely in the private network within an administrative domain may not have much security concerns. Further, implementation must ensure that each of the one or more runtime nodes are authenticated before setting up one or more bridge wires and messages are encrypted to ensure data privacy. Such implementations employing public key cryptography for bridge wire transport must ensure that the public keys of runtime nodes are shared in advance. This information may be included in the data flow configuration information section of the flow configuration file that is propagated to each of the one or more runtime nodes during distributed data flow deployment phase. Each of the one or more runtime nodes may periodically or on-demand refreshes key pair to improve the security posture of the overall system. Upon key pair refresh, each of the one or more runtime nodes may communicate a new public key to the controller 102 which in turn updates the distributed data flow with the new key. In such embodiment, the implementation of key pair refreshes may be triggered at configured intervals for enhanced security.

Furthermore, the connection establishing module 214 is configured to implement the one or more bridge wires with the one or more runtime nodes and the one or more flow neighbors for implementation of the distributed data flow model based on the established publisher-subscriber relationship. In an embodiment of the present disclosure, an autonomous set up of the one or more bridge wires without centralized coordinating broker includes having complete details of the one or more flow neighbour's reachability. The TCP connection setup between any two runtime nodes requires one of the runtime nodes to initiate a connection in INITIATE socket role while the other runtime node has been listening for connection in ACCEPT socket role regardless of which of the publisher and subscriber services makes use of the TCP connection. Each of the one or more runtime nodes includes the unique identification number which is assigned at the time of provisioning. The unique identification number and socket roles are included as part of each of the one or more runtime nodes' configuration in a flow file, such that a runtime node always knows unique identification number and the socket role of the one or more flow neighbours. When a pair of the one or more flow neighbours with identical socket roles try to set up a connection between them, they independently resolve and arrive at their final socket operations that are complementary. The one or more flow neighbours with larger unique identification number applies socket operation as per the configured socket role while its peering partner runtime node applies a complementary socket operation.

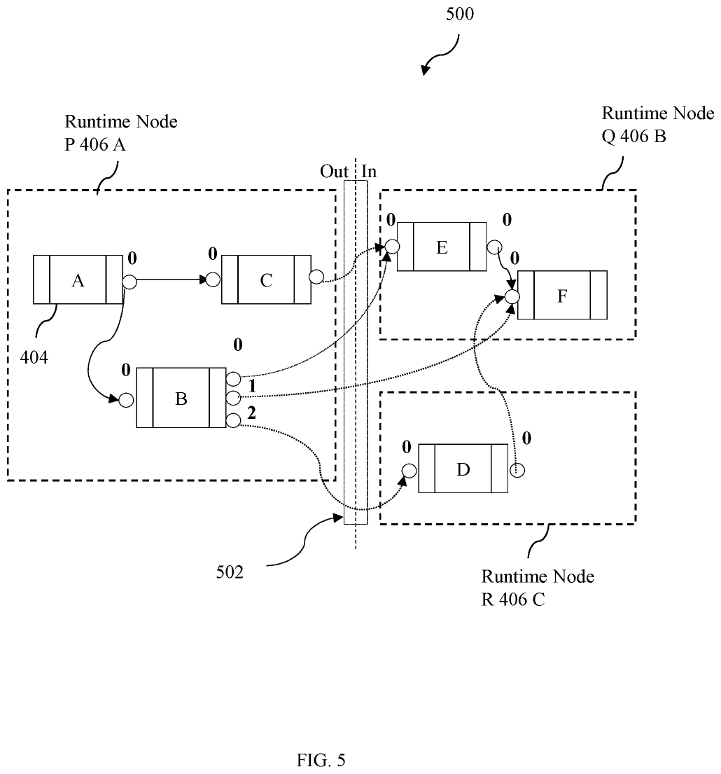

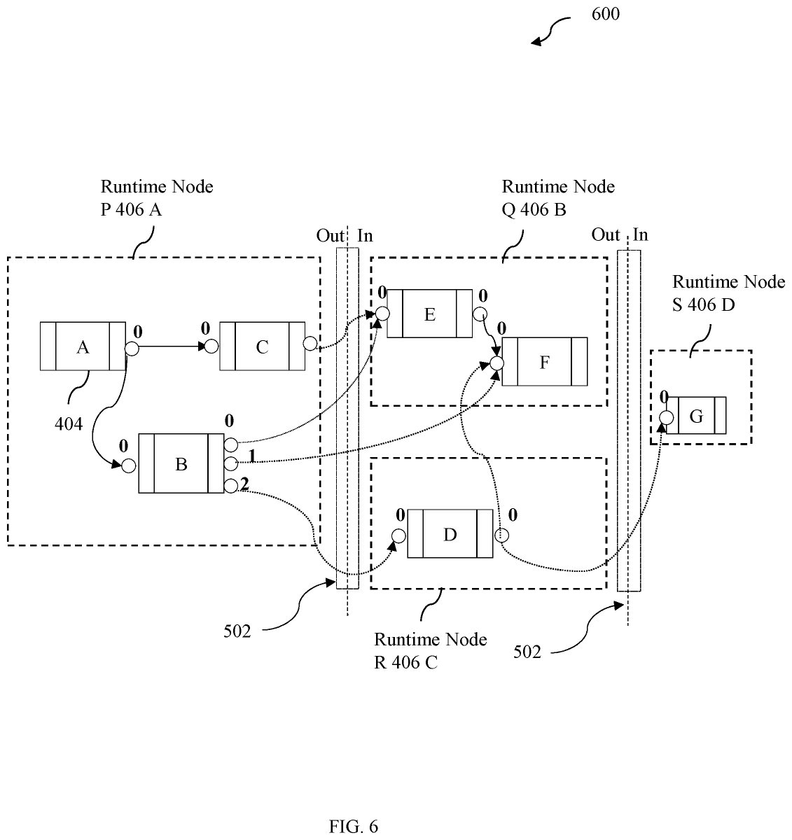

Further, the connection establishing module 214 implements the one or more bridge wires with the one or more runtime nodes and the one or more flow neighbors in a private network in absence of a firewall. In an embodiment of the present disclosure, implementing the one or more bridge wires in the private or on-premises network may include absence of firewalls which prevent runtime node to either initiate or accept TCP connections with others. One such embodiment of the private network scenario with implementation of the one or more bridge wires are represented in FIG. 4. The connection establishing module 214 implements the one or more bridge wires with the one or more runtime nodes and the one or more flow neighbors in a hybrid network of a public-private network in presence of a firewall. The firewall protects resources on enterprise networks from malicious agents from accessing via public networks, such as the internet. The firewall allows an inside user on enterprise networks to initiate a connection to an outside host such as a website on the internet but does not allow any connection to be originated from outside to an inside resource. Additionally, the firewalls are present to protect critical assets on operational networks from inadvertent access from corporate's own IT network. One such embodiment of the hybrid network scenario is depicted in FIG. 5. The connection establishing module 214 also implements the one or more bridge wires with the one or more runtime nodes and the one or more flow neighbors in a hierarchy of networks protected by one or more firewalls. One such embodiment of hierarchies of the one or more networks are represented in FIG. 6.

The data failure detection module 216 is configured to detect the loss of connectivity of the one or more networks, and the operational failure of one or more nodes and the one or more runtime nodes deployed in the distributed dataflow model based on implementation of the one or more bridge wires. In an embodiment of the present disclosure, the loss of connectivity is determined based on the implementation of the one or more bridge wires. Bridge wires are established only with one or more flow neighbors. Flow neighbors of a runtime node are the subset of other runtime nodes that have direct bridge wire connection. In FIG. 6, for runtime node Q, runtime nodes P and R are flow neighbors, but runtime node S is not a flow neighbor (there is no bridge wire between Q and S!). Hence if runtime node S goes down, runtime node Q will not detect it. It does not have to since it does not have a bridge wire connection. In an exemplary embodiment of the present disclosure, the one or more networks include private network, a public network, a hybrid network, and the like. In an embodiment of the present disclosure, the one or more nodes include one or more compute nodes, or one or more battery powered sensing nodes. In detecting the loss of connectivity of the one or more networks, and the operational failure of one or more nodes and the one or more runtime nodes deployed in the distributed dataflow model based on implementation of the one or more bridge wires, the data failure detection module 216 identifies the one or more nodes, the one or more interconnecting wires and the one or more runtime nodes deployed in the distributed dataflow model. Further, the data failure detection module 216 identifies a secured TCP connection established between the one or more runtime nodes deployed in the distributed dataflow model for transmission of flow messages. The data failure identification module establishes a peer-to-peer publisher on a message originating runtime node and a peer-to-peer subscriber on a message receiving runtime node based on an identification of the secured TCP connection established between each of the one or more runtime nodes. Furthermore, the data failure detection module 216 implements the one or more bridge wires with each of the one or more runtime nodes upon identifying a relationship established between the peer-to-peer publisher and the peer-to-peer subscriber between the one or more runtime nodes within the one or more networks.

The data failure detection module 216 detects the loss of connectivity of the one or more networks, and the operational failure of the one or more nodes and the one or more runtime nodes deployed in the distributed dataflow model based on implementation of the one or more bridge wires. In an embodiment of the present disclosure, the TCP connection established between the one or more runtime nodes includes initiation of connection by a publisher of a runtime node and listening for connection request by a peer-to-peer subscriber of another runtime node among the one or more runtime nodes, and initiation of connection by the peer-to-peer subscriber of the runtime node and listening connection request by the peer-to-peer publisher.

The cause determination module 218 is configured to determine the one or more root causes of the detected loss of connectivity. In an exemplary embodiment of the present disclosure, the one or more root causes of the detected loss of connectivity include a flow neighbor becomes active from an inactive state or a down state, data channel security keys of the one or more runtime nodes are expired, and the like. On publisher of a runtime node, a failure while attempting to send periodic heartbeat indicates that network or flow neighbor is down. Similarly, a subscriber of a runtime node detects network outage and flow neighbor down event when it does not receive a periodic heartbeat. Every runtime node tries to generate a new pair of data channel security keys BEFORE the current ones expire. However, when a runtime node is powered up after a long time, it would already have expired security keys on hand. When it uses them to establish bridge wires, an error is generated that points to key expiry.

The operation performing module 220 is configured to perform the one or more operations to attain the predefined level of resiliency of the distributed data flow model over the one or more bridge wires based on the detected loss of connectivity and the determined one or more root causes. In performing the one or more operations to attain the predefined level of resiliency of the distributed data flow model over the one or more bridge wires based on the detected loss of connectivity and the determined one or more root causes, the operation performing module 220 enables TCP keepalives by TCP connection utilized by the one or more bridge wires to prevent connections from timing out and getting dropped by one or more network devices upon determining that a flow neighbor becomes active from the inactive state or the down state. Further, the operation performing module 220 implements a heartbeat mechanism over the one or more bridge wires to indicate liveliness of the runtime node upon determining that the flow neighbor becomes active from the inactive state or the down state. When a peer-to-peer subscriber does not receive a “hello message” within a predetermined interval, the peer-to-peer subscriber assumes that the peer publisher is not active anymore and goes through the reconnection procedure for underlying the TCP connection. The publisher and subscriber services on the runtime need to be rebound to a new connection upon re-establishment of underlying TCP connection. The operation performing module 220 reestablishes the TCP connection through one or more socket operations upon determining that the flow neighbor becomes active from the inactive state or the down state. In an exemplary embodiment of the present disclosure, the one or more socket operations include an initiate operation, an accept operation, a listen operation, and the like. For example, if the runtime node's socket operation is INITIATE, it periodically attempts to initiate a new connection with flow neighbor until it succeeds. Similarly, if runtime node's socket operation is ACCEPT, the runtime node's socket performs LISTEN operation on network socket so that when the flow neighbor becomes active again the runtime node socket is able to ACCEPT connection initiation from the flow neighbor. The operation performing module 220 reduces implementation overhead based on automatic reconnection capability of the socket library on runtime node upon determining that the flow neighbor becomes active from the inactive state or the down state. To reduce implementation overhead, the one or more runtime nodes may use automatic reconnection option in sockets if the socket library supports such a capability.

Further, in performing the one or more operations to attain the predefined level of resiliency of the distributed data flow model over the one or more bridge wires based on the detected loss of connectivity and the determined one or more root causes, the operation performing module 220 utilizes a separate communication channel for one or more administrative tasks. In an embodiment of the present disclosure, the one or more administrative tasks include a flow file propagation from a controller 102 to a runtime node and a notification of runtime configuration changes from one or more runtime nodes to the controller 102 of the distributed data flow model upon determining that data channel security keys of the one or more runtime nodes are expired. The operation performing module 220 obtains separate security key pairs for the one or more runtime nodes upon determining that the data channel security keys of the one or more runtime nodes are expired. In implementations that require data security of the distributed data flow model, each of the one or more runtime nodes requires two different security key pairs one for securing control channel communications with the controller 102 and another for securing data channels underlying bridge wires between flow neighbors. Furthermore, the operation performing module 220 refreshes a data channel key pair via the one or more runtime nodes periodically or on demand to improve security posture of the distributed data flow model. In this process, the runtime node independently creates a new security key pair. The runtime node retains the private key of the key pair but shares the public key component with all other runtime nodes via the controller 102. The runtime sends a configuration update message to the controller 102 over control channel that includes new public key. The controller 102 updates runtime configurations and updates the DDF and/or its meta data with a new public key and distribute it to the one or more runtime nodes in the distributed data flow model for deployment. Any data channel key pair refresh on one or more runtime nodes triggers a distributed data flow and/or its meta data update, distribution and redeployment of the distributed data flow.

FIG. 3 is a block diagram illustrating a controller 102 for implementing the distributed data flow model, in accordance with an embodiment of the present disclosure. The controller 102 obtains the distributed data flow details from the user and registers the one or more runtime nodes 302 of the distributed data flow model based on the obtained distributed data flow details from the user. Further, the controller 102 receives data flow configuration information of the one or more runtime nodes 302 from each of the one or more runtime nodes 302 upon successful registration of the one or more runtime nodes 302. The controller 102 generates the flow configuration file of the predefined format for the one or more runtime nodes 302 upon the successful registration. If there is a change in the configuration of the one or more runtime nodes 302, then the one or more runtime nodes 302 promptly update the controller 102 thus enabling the controller 102 to maintain a repository or a distributed dataflow store 304 of latest runtime node configurations 306 for all runtime nodes. In an embodiment of the present disclosure, the one or more runtime nodes 302 may include one or more compute nodes equipped with a predetermined functionality for execution of distributed data flow. In an embodiment of the present disclosure, the distributed data flow is designed using a visual flow-based editor 308. The controller 102 includes the visual flow-based editor 308 configured to capture the distributed data flow details including a design of the distributed data flow model. In an embodiment of the present disclosure, the distributed data flow details are designed by the user 310. Further, the visual flow-based editor 308 deploys the DDF to each of the one or more runtime nodes 302. In an embodiment of the present disclosure, during the installation and provisioning process, each runtime node of the data distributed flow model registers with the controller 102 and shares the corresponding the data flow configuration information. During the deployment phase, each runtime in a DDF system receives complete DDF design from the controller 102, regardless of the portion of the DDF that has been assigned to the runtime node in the form of the flow configuration file. In an embodiment of the present disclosure, the computing system 104 obtains separate security key pairs for the one or more runtime nodes 302 upon determining that the data channel security keys of the one or more runtime nodes 302 are expired. In implementations that require data security of the distributed data flow model, each of the one or more runtime nodes 302 requires two different security key pairs one for securing control channel 312 communications with the controller 102 and another for securing data channels underlying bridge wires 314 between flow neighbors.

FIG. 4 is a block diagram illustrating an exemplary private network scenario of a system for implementing the distributed data flow model, in accordance with an embodiment of the present disclosure. In a private network 402, it is assumed that there are no firewalls that prevent a runtime node to either initiate or accept TCP connections with others. All runtime nodes with one or more nodes 404 in such a scenario assume default socket role and successfully establish bridge wires between flow neighbours autonomously. The private network as used herein includes three runtime nodes 406A, 406 B, 408 C such as P, Q and R respectively.

Assuming UID(P)<UID (R)<UID (Q):

P(a)->R(b) indicates: P is in socket role a, R is in socket role b, and a connection initiated by P is accepted by R. P->R is a resulting connection.

Connection Setup:

P(ACCEPT)->Q(ACCEPT),

P(ACCEPT)->R(ACCEPT) and

R(ACCEPT)->Q(ACCEPT)

Publisher Setup:

P creates peer-to-peer publishers on topics C0-E0, B0-E0, and B1-F0 and binds them to connection P->Q

P creates peer-to-peer publisher on topic B2-D0 and binds it to connection P->R

R creates peer-to-peer publisher on topic D0-F0 and binds it to connection R->Q

Subscriber Setup:

R creates peer-to-peer subscriber on topic B2-D0 and binds it to connection P->R

Q creates subscribers on topics C0-E0, B0-E0 and B1-F0 and binds them to connection P->Q Q creates peer-to-peer subscriber on topic D0-F0 and binds it to connection R->Q

FIG. 5 is a block diagram illustrating an exemplary hybrid network scenario 500 for implementing the distributed data flow model, in accordance with an embodiment of the present disclosure. Assuming in the hybrid network 500, runtime node P 406 A in socket role A is on the outside network of a firewall 502 (example: public cloud) and flow neighbour R in socket role B is on the inside network (corporate network) of firewall. Here, the runtime node P 406 A is on a public network and in ACCEPT socket role. Runtime nodes Q 406 B and R 406 C on a private network behind a firewall and are in INITIATE socket role.

Assuming UID(P)>UID(R)->UID(Q), then the distributed data flow is implemented in the hybrid network scenario as follows:

Connection Setup:

Q(INITIATE)->P (ACCEPT),

R(INITIATE)->P(ACCEPT), and,

R(INITIATE)->Q(INITIATE)

Publisher Setup:

P creates peer-to-peer publishers on topics C0-E0, B0-E0, and B1-F0 and binds them to connection Q->P

P creates peer-to-peer publisher on topic B2-D0 and binds it to connection R->P

R creates peer-to-peer publisher on topic D0-F0 and binds it to connection R->Q

Subscriber Setup:

R creates peer-to-peer subscriber on topic B2-D0 and binds it to connection R->P

Q creates peer-to-peer subscribers on topics C0-E0, B0-E0 and B1-F0 and binds them to connection Q->P

Q creates peer-to-peer subscriber on topic D0-F0 and binds it to connection R->Q

FIG. 6 is a block diagram illustrating exemplary hierarchies of three networks 600 protected by firewalls for implementing the distributed data flow model, in accordance with an embodiment of the present disclosure. In a scenario, runtime nodes 406 spread across three hierarchies of networks 600 protected by firewalls 502: P(ACCEPT),

Q(ACCEPT), X(ACCEPT), Y(ACCEPT) and A(INITIATE), B(INITIATE)

By choosing UID range for P&Q>UID range for X&Y>UID range for A&B

X(INITIATE) or Y(INITIATE)->P(ACCEPT) or Q (ACCEPT),

A(INITIATE) or B(INITIATE)->X(ACCEPT) or Y(ACCEPT), and

A(INITIATE) or B(INITIATE)->P(ACCEPT) or Q(ACCEPT)

Again, by choosing UID(P)>UID(Q) & UID(R)>UID(S):

The scenario in the hierarchies of network becomes:

Q(ACCEPT)->P(ACCEPT),

R(ACCEPT)->P (ACCEPT),

S(INITIATE)->R(ACCEPT) and

R(ACCEPT)->Q(ACCEPT), if UID(Q)>UID(R), else Q(ACCEPT)->R(ACCEPT).

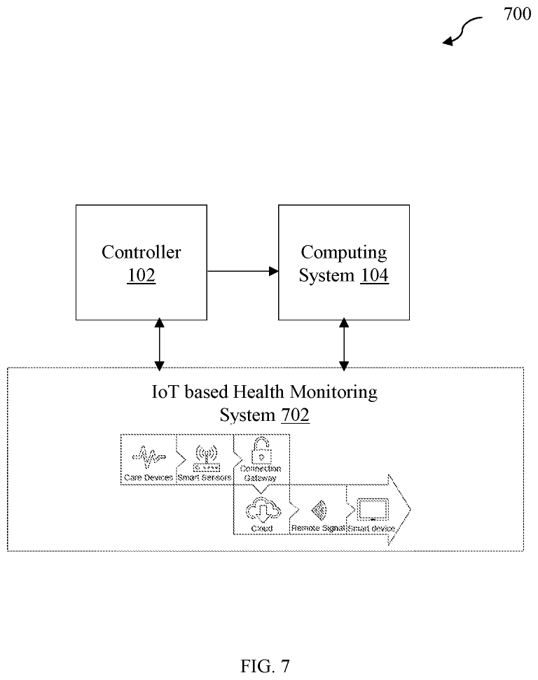

FIG. 7 is a schematic representation depicting operation of the exemplary computing system 104 for implementing and managing the distributed data flow model, in accordance with an embodiment of the present disclosure. In an embodiment of the present disclosure, a system 700 for implementation of the distributed data flow model includes the computing system 104, the controller 102 and an IoT technology-based healthcare monitoring system 702. The system 700 is well suited for IoT applications in which data originates from non-human sources, such as sensors/machines and eventually used for further processing. In the system 700, health parameters of users are fetched in raw format from a wearable device associated with the user and further utilized for processing. The data ingested from the sensors of the wearable device are stored in the database or handed off to other application entities to collect, analyse and act based on the data. Based on the data gathered from the non-human resources, the system 700 provides a design & implementation methodology for a distributed flow model for the IoT technology-based healthcare monitoring system 702.

In operation, the controller 102 registers the one or more runtime nodes 302 of the distributed data flow model by capturing the distributed data flow details from the user. For example, each of the one or more runtime nodes 302 of the distributed data flow model registers with the controller 102 and shares its configuration information. If there is a change in the configuration of the at least one runtime, then the one or more runtime nodes 302 promptly update the controller 102 thus enabling the controller 102 to maintain a repository of latest configurations for all runtime nodes. In one embodiment, the one or more runtime nodes 302 may include one or more compute nodes equipped with a predetermined functionality for execution of distributed data flow. The controller 102 is also configured to create a flow configuration file such as JSON file format for the at least one runtime. For example, the at least one runtime may include one or more nodes interconnected with one or more wires. The one or more nodes are processing blocks which are part of a distributed data flow and responsible for processing and analysis of the IoT technology-based healthcare monitoring system 702.

Once, the flow configuration file is created, the one or more nodes and the one or more interconnecting wires of the one or more runtime nodes 302 are deployed based on one or more identified portions of the distributed data flow model from the flow configuration file. Further, the one or more flow neighbors associated with each of the one or more runtime nodes 302 are identified based on the extracted data flow configuration information. Further, the publisher-subscriber service information is determined for each of the identified one or more flow neighbors based on the extracted data flow configuration information. Furthermore, peer-to-peer pub/sub clients over point-to-point connections is also enabled to implement bridge wires in the distributed data flow model that cross runtime boundaries. In the distributed data flow model, each of the one or more runtime nodes 302 has knowledge of the entire distributed data flow and latest configuration of the one or more flow neighbours with which it has bridge wire attachments.

Further, the one or more socket roles and the unique identification number corresponding to each of the one or more flow neighbors are identified based on the obtained flow configuration file upon determining the publisher and the subscriber service information. Based on the one or more socket roles, the system 700 enables each of the one or more runtime nodes 302 independently, without centralized coordination to establish point to point, secure TCP connections with its flow neighbours and set up pub/sub relationships for forwarding flow messages. The TCP connection may be secure or insecure depending on the deployment environment. Further, the system 700 implements one or more bridge wires with the one or more runtime nodes 302 and the one or more flow neighbours for implementation of the distributed data flow model based on the publisher-subscriber relationship. In an embodiment of the present disclosure, the system 700 detects the loss of connectivity of the one or more networks, and the operational failure of one or more nodes and the one or more runtime nodes 302 deployed in the distributed dataflow model based on implementation of the one or more bridge wires. Further, one or more root causes of the detected loss of connectivity, such as flow neighbor becomes active from an inactive state or a down state, and data channel security keys of the one or more runtime nodes 302 are expired, are determined. Further, the one or more operations are performed to attain a predefined level of resiliency of the distributed data flow model over the one or more bridge wires based on the detected loss of connectivity and the determined one or more root cause.

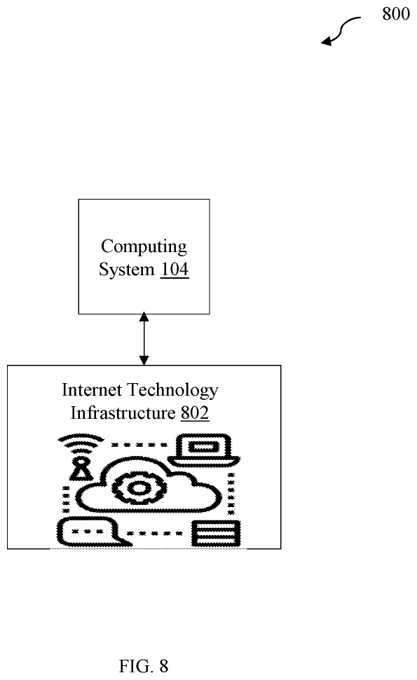

FIG. 8 is a schematic representation depicting operation of the exemplary computing system 104 for implementing and managing the distributed data flow model, in accordance with another embodiment of the present disclosure. The distributed dataflow model using a dataflow programming model for building IoT applications and services has been designed as a run-time for individual devices. The system 800 is well suited for IoT applications in which data originates from non-human sources such as sensors/machines and eventually consumed for further processing. Considering an example, where the distributed data flow model is built over internet technology infrastructure 802. In such a scenario, generally, one or more constituents of the Internet technology infrastructure 802 do not guarantee fail-proof operation over extended periods, sometimes there is loss of network connectivity and drop in traffic, compute nodes can fail, and battery-powered sensor nodes may purposefully sleep to conserve energy and so on.

In order to overcome such issues, the system 800 provides reasonable assurance of functioning in such conditions thereby improving resiliency of the distributed data flow model. The system 800 enables the distributed dataflow model to recover from link failures and temporary loss of connectivity and continue to be operational. Failure of one of the participating runtime nodes should not render the rest of the DDF non-operational. The system 800 includes the computing system 104 to identify the one or more nodes, the one or more interconnecting wires and the one or more runtime nodes 302 deployed in the distributed dataflow model. For example, the one or more nodes may include one or more compute nodes or one or more battery powered sensor nodes. In the example used herein, each of the one or more runtime nodes 302 in the distributed data flow model receives the flow configuration file from a controller 102 prior to establishing the publisher and the subscriber relationship.

Once, the deployment of the one or more nodes, the one or more wires and the one or more runtime nodes 302 are identified, the secured TCP connection established between the one or more runtime nodes 302 deployed in the distributed dataflow model is identified for transmission of flow messages. For example, the transmission control protocol connection established between the one or more runtime nodes 302 may include initiation of the TCP connection by a peer-to-peer publisher of one of a runtime node and listening for connection request by a peer-to-peer subscriber of another runtime node among the one or more runtime nodes 302.

Upon establishment of the TCP connection, a peer-to-peer publisher is established on a message originating runtime node and a peer-to-peer subscriber is established on a message receiving runtime node based on an identification of the secured TCP connection established between each of the one or more runtime nodes 302. Further, the one or more bridge wires are implemented with each of the one or more runtime nodes 302 upon identifying a relationship established between the peer-to-peer publisher and the peer-to-peer subscriber between the one or more runtime nodes 302 within the one or more networks. For example, the at least one network may include a private network, a public network and a hybrid network.

Once, the one or more bridge wires are implemented the computing system 104 detects the loss of connectivity of the one or more networks, and the operational failure of the one or more nodes and the one or more runtime nodes 302 deployed in the distributed dataflow model based on implementation of the one or more bridge wires. Further, the one or more root causes of the detected loss of connectivity, such as flow neighbor becomes active from an inactive state or a down state, and data channel security keys of the one or more runtime nodes 302 are expired, are determined. Further, the one or more operations are performed to attain a predefined level of resiliency of the distributed data flow model over the one or more bridge wires based on the detected loss of connectivity and the determined one or more root cause. Thus, the resiliency achieved through several connection mechanisms ensures reliable message delivery over bridge wires and enables reconnecting peer-to-peer communicating nodes by elimination of centralized message broker to improve system resilience and also eliminating a single point of failure in the data plane. This enables a significant portion of distributed data flow processing at the edge of the network where IoT data originates without incurring additional costs involved in sending data to the message broker.

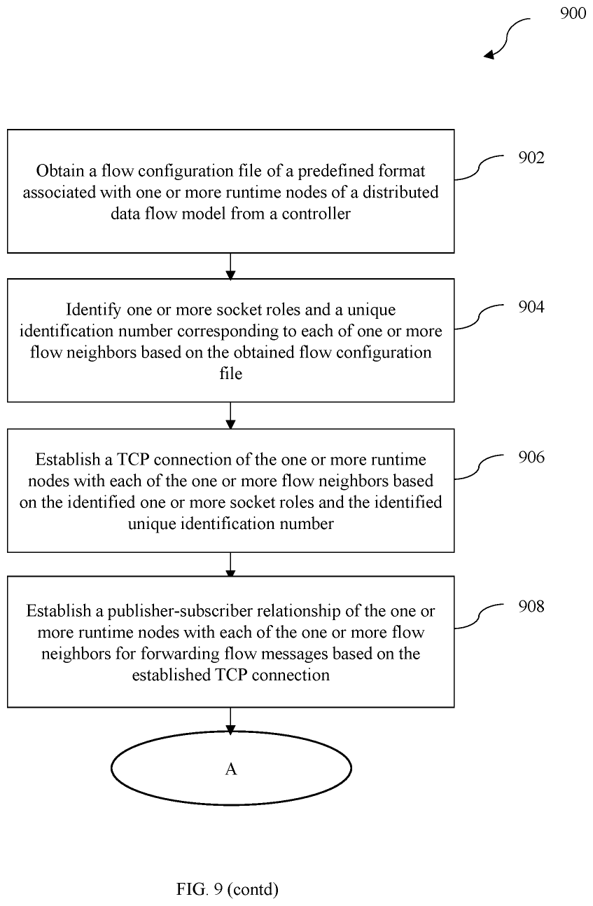

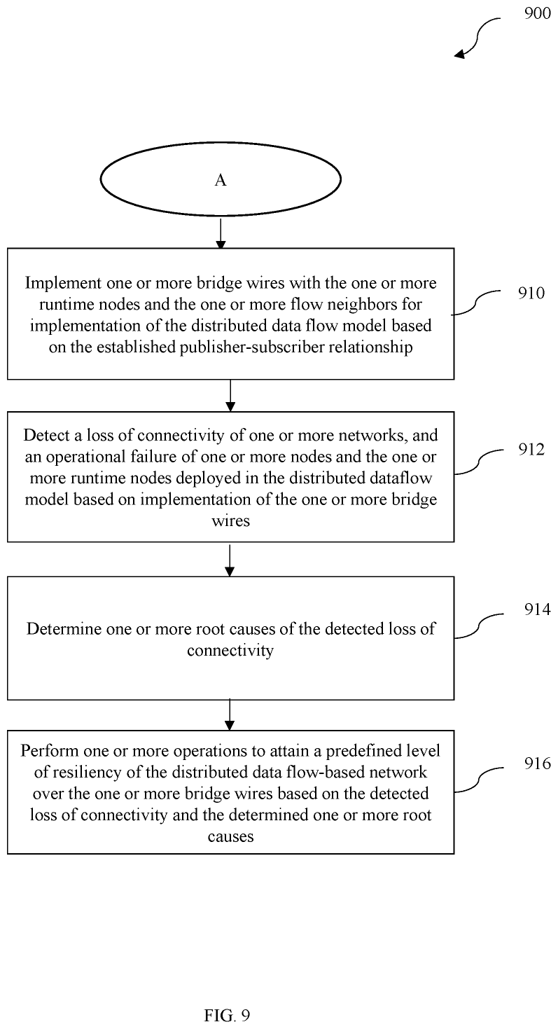

FIG. 9 is a process flow diagram illustrating an exemplary AI-based method for implementing and managing the distributed data flow model, in accordance with an embodiment of the present disclosure. At step 902, a flow configuration file of a predefined format associated with the one or more runtime nodes 302 of the distributed data flow model is obtained from a controller 102. In an embodiment of the present disclosure, the one or more runtime nodes are one or more edge computing runtime nodes. In an embodiment of the present disclosure, the distributed data flow model is defined as one dataflow capable of running a portion of a Directed Acyclic Graph (DAG) composed of ‘nodes’ and ‘wires’ independently. The term ‘distributed data flow’ is defined as a dataflow that spans runtime nodes. Each runtime node executes a portion of distributed flow when successfully deployed. Further, the distributed dataflow mode may include a dataflow model distributed over the one or more runtime nodes 302. The flow configuration file includes a JavaScript Object Notation (JSON) file format including data flow configuration information. In an exemplary embodiment of the present disclosure, the data flow configuration information includes flow design of the one or more runtime nodes 302, one or more node configurations, one or more interconnecting wires, one or more runtime node configurations, and the like. In such embodiment, the one or more runtime node configurations may include, but not limited to, port numbers, Internet Protocol (IP) address, public key information of the public-key cryptography and the like. In an embodiment of the present disclosure, the port numbers may include pre-determined port numbers for publisher and subscriber services with listening socket role. The one or more runtime nodes 302 are one or more compute nodes equipped with a predetermined functionality for execution of a distributed data flow. In an embodiment of the present disclosure, the computing runtime node is defined as a node which provides ephemeral storage, networking, memory, and processing resources that is used by virtual machine instances.

In an embodiment of the present disclosure, the controller 102 is configured to obtain distributed data flow details from a user. In an exemplary embodiment of the present disclosure, the distributed data flow details include a design of the distributed data flow model. The controller 102 registers the one or more runtime nodes 302 of the distributed data flow model based on the obtained distributed data flow details from the user. In an embodiment of the present disclosure, the distributed data flow model includes a dataflow model distributed over the one or more runtime nodes 302. Further, the controller 102 receives the data flow configuration information of the one or more runtime nodes 302 from each of the one or more runtime nodes 302 upon successful registration of the one or more runtime nodes 302. The controller 102 generates the flow configuration file of the predefined format for the one or more runtime nodes 302 upon the successful registration.

At step 904, one or more socket roles and a unique identification number corresponding to each of one or more flow neighbors are identified based on the obtained flow configuration file. In identifying the one or more socket roles and the unique identification number corresponding to each of the one or more flow neighbors based on the obtained flow configuration file upon determining the publisher and the subscriber service information, the method 900 includes identifying one or more portions of the distributed data flow network based on the obtained flow configuration file. Further, the method 900 includes deploying one or more nodes and one or more interconnecting wires on the one or more runtime nodes 302 based on the identified one or more portions of one or more distributed dataflows. As used herein, the term ‘nodes’ are defined as processing blocks in flow-based programming paradigm. In an embodiment of the present disclosure, the processing blocks or processors, as used herein, means any type of computational circuit, such as, but not limited to, a microprocessor, a microcontroller, a complex instruction set computing microprocessor, a reduced instruction set computing microprocessor, software routine or a function in the list, a very long instruction word microprocessor, an explicitly parallel instruction computing microprocessor, a digital signal processor, a function block written in software or any other type of processing circuit, or a combination thereof. Furthermore, the one or more nodes include one or more input ports and one or more output ports. In an embodiment of the present disclosure, the one or more interconnecting wires correspond to flow of messages from an output port of a node to an input port of another node. In an embodiment of the present disclosure, the one or more flow messages over interconnecting wires are represented internally as JSON objects with necessary and sufficient contract to support functionality and connectivity of the one or more nodes. The method 900 includes extracting the data flow configuration information from the flow configuration file for deploying the one or more nodes and the one or more interconnecting wires. Further, the method 900 includes identifying the one or more flow neighbors associated with each of the one or more runtime nodes 302 based on the extracted data flow configuration information. In an embodiment of the present disclosure, the one or more flow neighbors include two runtime nodes that have one or more bridge wires between the two runtime nodes. In an embodiment of the present disclosure, the one or more bridge wires are defined as a wire in a flow that crosses runtime node boundaries. Furthermore, the method 900 includes determining publisher-subscriber service information for each of the identified one or more flow neighbors based on the extracted data flow configuration information. As used herein, the term ‘publisher’ is defined as an entity responsible for posting messages to a topic. Similarly, the term ‘subscriber’ is defined as an application which registers itself with a desired topic to receive the appropriate messages. The term ‘topic’ is defined as an intermediary channel that maintains a list of subscribers to relay messages to that are received from publishers. In an exemplary embodiment of the present disclosure, the publisher-subscriber service information includes registration information of the peer-to-peer publisher and the peer-to-peer subscriber with a unique topic between the one or more runtime nodes 302 and the one or more flow neighbors. The method 900 includes identifying the one or more socket roles and the unique identification number corresponding to each of the one or more flow neighbors based on the obtained flow configuration file upon determining the publisher and the subscriber service information. In an exemplary embodiment of the present disclosure, the one or more socket rules comprise an initiate socket role, an accept socket role, or a combination thereof. In an embodiment of the present disclosure, publisher-subscriber models with the publisher-subscriber relationship solve the problem of ‘one to many’ and ‘many to one’ connections needed for the distributed data flow-based model.

At step 906, a TCP connection of the one or more runtime nodes 302 is established with each of the one or more flow neighbors based on the identified one or more socket roles and the identified unique identification number. The TCP connection enables TCP keepalives for preventing deactivation of the established TCP connection. In an embodiment of the present disclosure, a single TCP connection is established between each pair of flow neighbors from each of the one or more runtime nodes 302. In an embodiment of the present disclosure, the TCP connection may be secure or insecure depending on the deployment environment. A dedicated TCP connection is not created for each bridge wire instead a single TCP connection is established between each pair of flow neighbours from each of the one or more runtime nodes 302. In some cases, certain publisher/subscriber implementations may not allow sharing of a single TCP connection by both the publisher and the subscriber service. In such cases, a pair of TCP connections may be necessary to support one or more bridge wires in both directions. Since the performance and memory consumption of runtime depends on the number of TCP connections, this approach improves scalability as the number of TCP connections increases linearly with the number of runtimes instead of the number of bridge wires in the distributed data flow model.

At step 908, a publisher-subscriber relationship of the one or more runtime nodes 302 is established with each of the one or more flow neighbors for forwarding flow messages based on the established TCP connection. In an embodiment of the present disclosure, the publisher-subscriber relationship includes a relationship between a peer-to-peer publisher on a message originating runtime node and a peer-to-peer subscriber on a message receiving runtime node. In an embodiment of the present disclosure, the distributed data flow model deployed entirely in the private network within an administrative domain may not have much security concerns. Further, implementation must ensure that each of the one or more runtime nodes 302 are authenticated before setting up one or more bridge wires and messages are encrypted to ensure data privacy. Such implementations employing public key cryptography for bridge wire transport must ensure that the public keys of runtime nodes are shared in advance. This information may be included in the data flow configuration information section of the flow configuration file that is propagated to each of the one or more runtime nodes 302 during distributed data flow deployment phase. Each of the one or more runtime nodes 302 may periodically or on-demand refreshes key pair to improve the security posture of the overall system. Upon key pair refresh, each of the one or more runtime nodes 302 may communicate a new public key to the controller 102 which in turn updates the distributed data flow with the new key. In such embodiment, the implementation of key pair refreshes may be triggered at configured intervals for enhanced security.

At step 910, one or more bridge wires are implemented with the one or more runtime nodes 302 and the one or more flow neighbors for implementation of the distributed data flow model based on the established publisher-subscriber relationship. In an embodiment of the present disclosure, an autonomous set up of the one or more bridge wires without a centralized coordinating broker includes having complete details of the one or more flow neighbour's reachability. The TCP connection setup between any two runtime nodes requires one of the runtime nodes to initiate a connection in INITIATE socket role while the other runtime node has been listening for connection in ACCEPT socket role regardless of which of the publisher and subscriber services makes use of the TCP connection. Each of the one or more runtime nodes 302 includes the unique identification number which is assigned at the time of provisioning. The unique identification number and socket roles are included as part of each of the one or more runtime nodes 302′ configuration in a flow file, such that an runtime node always knows unique identification number and the socket role of the one or more flow neighbours. When a pair of the one or more flow neighbours with identical socket roles try to set up a connection between them, they independently resolve and arrive at their final socket operations which are complementary. The one or more flow neighbours with larger unique identification number applies socket operation as per the configured socket role while its peering partner runtime node applies a complementary socket operation.

Further, the method 900 includes implementing the one or more bridge wires with the one or more runtime nodes 302 and the one or more flow neighbors in a private network in absence of a firewall. In an embodiment of the present disclosure, implementing the one or more bridge wires in the private or on-premises network may include absence of firewalls which prevent runtime node to either initiate or accept TCP connections with others. The method 900 includes implementing the one or more bridge wires with the one or more runtime nodes 302 and the one or more flow neighbors in a hybrid network of a public-private network in presence of a firewall. The firewall protects resources on enterprise networks from malicious agents from accessing via public networks, such as the internet. The firewall allows an inside user on enterprise networks to initiate a connection to an outside host such as a website on the internet but does not allow any connection to be originated from outside to an inside resource. Additionally, the firewalls are present to protect critical assets on operational networks from inadvertent access from corporate's own IT network. The method 900 includes implementing the one or more bridge wires with the one or more runtime nodes 302 and the one or more flow neighbors in a hierarchy of networks protected by one or more firewalls.

At step 912, a loss of connectivity of the one or more networks, and an operational failure of one or more nodes and the one or more runtime nodes 302 deployed in the distributed dataflow model are detected based on implementation of the one or more bridge wires. In an exemplary embodiment of the present disclosure, the one or more networks include private network, a public network, a hybrid network, and the like. In an embodiment of the present disclosure, the one or more nodes include one or more compute nodes, or one or more battery powered sensing nodes. In detecting the loss of connectivity of the one or more networks, and the operational failure of one or more nodes and the one or more runtime nodes 302 deployed in the distributed dataflow model based on implementation of the one or more bridge wires, the method 900 includes identifying the one or more nodes, the one or more interconnecting wires and the one or more runtime nodes 302 deployed in the distributed dataflow model. Further, the method 900 includes identifying a secured TCP connection established between the one or more runtime nodes 302 deployed in the distributed dataflow model for transmission of flow messages. The method 900 includes establishing a peer-to-peer publisher on a message originating runtime node and a peer-to-peer subscriber on a message receiving runtime node based on an identification of the secured TCP connection established between each of the one or more runtime nodes 302. Furthermore, the method 900 includes implementing the one or more bridge wires with each of the one or more runtime nodes 302 upon identifying a relationship established between the peer-to-peer publisher and the peer-to-peer subscriber between the one or more runtime nodes 302 within the one or more networks. The method 900 includes detecting the loss of connectivity of the one or more networks, and the operational failure of the one or more nodes and the one or more runtime nodes 302 deployed in the distributed dataflow model based on implementation of the one or more bridge wires. In an embodiment of the present disclosure, the TCP connection established between the one or more runtime nodes 302 includes initiation of connection by a peer-to-peer publisher of a runtime node and listening for connection request by a peer-to-peer subscriber of another runtime node among the one or more runtime nodes 302, and initiation of connection by the peer-to-peer subscriber of the runtime node and listening connection request by the peer-to-peer publisher.

At step 914, one or more root causes of the detected loss of connectivity is determined. In an exemplary embodiment of the present disclosure, the one or more root causes of the detected loss of connectivity include a flow neighbor becomes active from an inactive state or a down state, data channel security keys of the one or more runtime nodes 302 are expired, and the like.

At step 916, one or more operations are performed to attain the predefined level of resiliency of the distributed data flow model over the one or more bridge wires based on the detected loss of connectivity and the determined one or more root causes. In performing the one or more operations to attain the predefined level of resiliency of the distributed data flow model over the one or more bridge wires based on the detected loss of connectivity and the determined one or more root causes, the method 900 includes enabling TCP keepalives by TCP connection utilized by the one or more bridge wires to prevent connections from timing out and getting dropped by one or more network devices upon determining that a flow neighbor becomes active from the inactive state or the down state. Further, the method 900 includes implementing a heartbeat mechanism over the one or more bridge wires to indicate liveliness of the runtime node upon determining that the flow neighbor becomes active from the inactive state or the down state. When a peer-to-peer subscriber does not receive a “hello message” within a predetermined interval, the peer-to-peer subscriber assumes that the peer publisher is not active anymore and goes through the reconnection procedure for underlying the TCP connection. The publisher and subscriber services on the runtime need to be rebound to a new connection upon re-establishment of underlying TCP connection. The method 900 includes reestablishing the TCP connection through one or more socket operations upon determining that the flow neighbor becomes active from the inactive state or the down state. In an exemplary embodiment of the present disclosure, the one or more socket operations include an initiate operation, an accept operation, a listen operation, and the like. For example, if the runtime node's socket operation is INITIATE, it periodically attempts to initiate a new connection with flow neighbor until it succeeds. Similarly, if runtime node's socket operation is ACCEPT, the runtime node's socket performs LISTEN operation on network socket so that when the flow neighbor becomes active again the runtime node socket is able to ACCEPT connection initiation from the flow neighbor. The method 900 includes reducing implementation overhead based on automatic reconnection capability of the socket library on runtime node upon determining that the flow neighbor becomes active from the inactive state or the down state. To reduce implementation overhead, the one or more runtime nodes 302 may use automatic reconnection option in sockets if the socket library supports such a capability.

Further, in performing the one or more operations to attain the predefined level of resiliency of the distributed data flow model over the one or more bridge wires based on the detected loss of connectivity and the determined one or more root causes, the method 900 includes utilizing a separate communication channel for one or more administrative tasks. In an embodiment of the present disclosure, the one or more administrative tasks include a flow file propagation from a controller 102 to a runtime node and a notification of runtime configuration changes from one or more runtime nodes 302 to the controller 102 of the distributed data flow model upon determining that data channel security keys of the one or more runtime nodes 302 are expired. The method 900 includes obtaining separate security key pairs for the one or more runtime nodes 302 upon determining that the data channel security keys of the one or more runtime nodes 302 are expired. In implementations that require data security of the distributed data flow model, each of the one or more runtime nodes 302 requires two different security key pairs one for securing control channel communications with the controller 102 and another for securing data channels underlying bridge wires between flow neighbors. Furthermore, the method 900 includes refreshing a data channel key pair via the one or more runtime nodes 302 periodically or on demand to improve security posture of the distributed data flow model. In this process, the runtime node independently creates a new security key pair. The runtime node retains the private key of the key pair but shares the public key component with all other runtime nodes via the controller 102. The runtime sends a configuration update message to the controller 102 over control channel that includes new public key. The controller 102 updates runtime configurations and updates the DDF and/or its meta data with a new public key and distribute it to the one or more runtime nodes 302 in the distributed data flow model for deployment. Any data channel key pair refresh on one or more runtime nodes 302 triggers a distributed data flow and/or its meta data update, distribution and redeployment of the distributed data flow.

The AI-based method 900 may be implemented in any suitable hardware, software, firmware, or combination thereof.

Thus, various embodiments of the present system provide a solution to implement and manage the distributed data flow model. The computing system 104 enables elimination of centralized message broker which improves system resilience by also eliminating a single point of failure in the data plane. This enables a significant portion of distributed data flow processing at the edge of the network where IoT data originates without incurring additional costs involved in sending data to the message broker. Moreover, the computing system 104 enables direct transport of flow messages between flow neighbors or peer-to-peer messaging which reduces the latency and supports real-time processing requirements of time-critical applications. Furthermore, the computing system 104 improves overall security posture of the distributed data flow model when the one or more runtime nodes 302 need to use public networks for communication without a need to modify existing firewall configurations. Also, the present computing system 104 reduces the complexity & cost of overall distributed data flow model implementation by eliminating the need to install one or more Message Queuing Telemetry Transport (MQTT) message brokers. The computing system 104 provides a resilient distributed data flow method for reconnecting peer-to-peer communicating nodes.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. For example, a group of runtime nodes that share identical runtime configurations and have UID assigned at the group level may have identical portions of the DDF assigned in the flow configuration file. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

We claim:

1. A computing system for implementing and managing a distributed data flow model, the computing system comprising:
one or more hardware processors; and
a memory coupled to the one or more hardware processors, wherein the memory comprises a plurality of modules in the form of programmable instructions executable by the one or more hardware processors, and wherein the plurality of modules comprises:
a data obtaining module configured to obtain a flow configuration file of a predefined format associated with one or more runtime nodes of a distributed data flow model from a controller, wherein the flow configuration file comprises a JavaScript Object Notation (JSON) file format comprising data flow configuration information, wherein the data flow configuration information comprises flow design of the one or more runtime nodes, one or more node configurations, one or more interconnecting wires, and one or more runtime node configurations, and wherein the one or more runtime nodes are one or more compute nodes equipped with a predetermined functionality for execution of a distributed data flow;
a bridge wire identification module configured to identify one or more socket roles and a unique identification number corresponding to each of one or more flow neighbors based on the obtained flow configuration file;
a connection establishing module configured to:
establish a Transmission Control Protocol (TCP) connection of the one or more runtime nodes with each of the one or more flow neighbors based on the identified one or more socket roles and the identified unique identification number, wherein the TCP connection enables TCP keepalives for preventing deactivation of the established TCP connection, and wherein a single TCP connection is established between each pair of flow neighbors from each of the one or more runtime nodes;
establish a publisher-subscriber relationship of the one or more runtime nodes with each of the one or more flow neighbors for forwarding flow messages based on the established TCP connection, wherein the publisher-subscriber relationship comprises a relationship between a peer-to-peer publisher on a message originating runtime node and a peer-to-peer subscriber on a message receiving runtime node; and
implement one or more bridge wires with the one or more runtime nodes and the one or more flow neighbors for implementation of the distributed data flow model based on the established publisher-subscriber relationship;
a data failure detection module configured to detect a loss of connectivity of one or more networks, and an operational failure of one or more nodes and the one or more runtime nodes deployed in the distributed dataflow model based on implementation of the one or more bridge wires, wherein the one or more nodes comprise one of: one or more compute nodes and one or more battery powered sensing nodes;
a cause determination module configured to determine one or more root causes of the detected loss of connectivity; and
an operation performing module configured to perform one or more operations to attain a predefined level of resiliency of the distributed data flow model over the one or more bridge wires based on the detected loss of connectivity and the determined one or more root causes.

2. The computing system of claim 1, wherein the controller is configured to:
obtain distributed data flow details from a user, wherein the distributed data flow details comprise a design of the distributed data flow model, wherein the controller registers the one or more runtime nodes of the distributed data flow model based on the obtained distributed data flow details from the user, wherein the distributed data flow model comprise a dataflow model distributed over the one or more runtime nodes, and wherein the one or more runtime nodes are one or more edge computing runtime nodes;
receive the data flow configuration information of the one or more runtime nodes from each of the one or more runtime nodes upon successful registration of the one or more runtime nodes; and
generate the configuration file of the predefined format for the one or more runtime nodes upon the successful registration.

3. The computing system of claim 1, wherein in identifying the one or more socket roles and the unique identification number corresponding to each of the one or more flow neighbors based on the obtained flow configuration file upon determining the publisher and the subscriber service information, the bridge wire identification module is configured to:
identify one or more portions of the distributed data flow network based on the obtained flow configuration file;
deploy one or more nodes and one or more interconnecting wires on the one or more runtime nodes based on the identified one or more portions of one or more distributed dataflows, wherein the one or more nodes are processing blocks in flow-based programming paradigm, wherein the processing blocks are a type of computational circuit comprising at least one of: microprocessor, a microcontroller, a complex instruction set computing microprocessor, a reduced instruction set computing microprocessor, software routine, a function in the list, a very long instruction word microprocessor, an explicitly parallel instruction computing microprocessor, and a digital signal processor, wherein the one or more nodes comprise one or more input ports and one or more output ports, and wherein the one or more interconnecting wires correspond to flow of messages from an output port of a node to an input port of another node;
extract the data flow configuration information from the flow configuration file for deploying the one or more nodes and the one or more interconnecting wires;
identify the one or more flow neighbors associated with each of the one or more runtime nodes based on the extracted data flow configuration information, wherein the one or more flow neighbors comprise two runtime nodes that have one or more bridge wires between the two runtime nodes, and wherein the one or more bridge wires are defined as a wire in a flow that crosses runtime node boundaries;
determine publisher-subscriber service information for each of the identified one or more flow neighbors based on the extracted data flow configuration information, wherein the publisher-subscriber service information comprises registration information of a peer-to-peer publisher and a peer-to-peer subscriber with a unique topic between the one or more runtime nodes and the one or more flow neighbors; and
identify the one or more socket roles and the unique identification number corresponding to each of the one or more flow neighbors based on the obtained flow configuration file upon determining the publisher and the subscriber service information, wherein the one or more socket rules comprise at least one of: an initiate socket role and an accept socket role.

4. The computing system of claim 1, wherein the connection establishing module is configured to:
implement the one or more bridge wires with the one or more runtime nodes and the one or more flow neighbors in a private network in absence of a firewall;
implement the one or more bridge wires with the one or more runtime nodes and the one or more flow neighbors in a hybrid network of a public-private network in presence of a firewall; and
implement the one or more bridge wires with the one or more runtime nodes and the one or more flow neighbors in a hierarchy of networks protected by one or more firewalls.

5. The computing system of claim 1, wherein the one or more root causes of the detected loss of connectivity comprise a flow neighbor becomes active from one of: an inactive state and a down state, and data channel security keys of the one or more runtime nodes are expired.

6. The computing system of claim 1, wherein in performing the one or more operations to attain the predefined level of resiliency of the distributed data flow model over the one or more bridge wires based on the detected loss of connectivity and the determined one or more root causes, the operation performing module is configured to:
enable TCP keepalives by TCP connection utilized by the one or more bridge wires to prevent connections from timing out and getting dropped by one or more network devices upon determining that a flow neighbor becomes active from one of: an inactive state and a down state;
implement a heartbeat mechanism over the one or more bridge wires to indicate liveliness of the runtime node upon determining that the flow neighbor becomes active from one of: the inactive state and the down state;
reestablish the TCP connection through one or more socket operations upon determining that the flow neighbor becomes active from one of: the inactive state and the down state, wherein the one or more socket operations comprise an initiate operation, an accept operation, and a listen operation; and
reduce implementation overhead based on automatic reconnection capability of the socket library on runtime node upon determining that flow neighbor becomes active from one of: the inactive state and the down state.

7. The computing system of claim 1, wherein in performing the one or more operations to attain the predefined level of resiliency of the distributed data flow model over the one or more bridge wires based on the detected loss of connectivity and the determined one or more root causes, the operation performing module is configured to:
utilize a separate communication channel for one or more administrative tasks, wherein the one or more administrative tasks comprise a flow file propagation from a controller to a runtime node and a notification of runtime configuration changes from one or more runtime nodes to the controller of the distributed data flow model upon determining that data channel security keys of the one or more runtime nodes are expired;
obtain separate security key pairs for the one or more runtime nodes upon determining that the data channel security keys of the one or more runtime nodes are expired; and
refresh a data channel key pair via the one or more runtime nodes one of: periodically and on demand to improve security posture of the distributed data flow model.

8. The computing system of claim 1, wherein the one or more networks comprise private network, a public network and a hybrid network.

9. The computing system of claim 1, wherein in detecting the loss of connectivity of the one or more networks, and the operational failure of one or more nodes and the one or more runtime nodes deployed in the distributed dataflow model based on implementation of the one or more bridge wires, the data failure detection module is configured to:
identify the one or more nodes, the one or more interconnecting wires and the one or more runtime nodes deployed in the distributed dataflow model;
identify a secured TCP connection established between the one or more runtime nodes deployed in the distributed dataflow model for transmission of flow messages;
establish a peer-to-peer publisher on a message originating runtime node and a peer-to-peer subscriber on a message receiving runtime node based on an identification of the secured TCP connection established between each of the one or more runtime nodes;
implement the one or more bridge wires with each of the one or more runtime nodes upon identifying a relationship established between the peer-to-peer publisher and the peer-to-peer subscriber between the one or more runtime nodes within the one or more networks; and
detect the loss of connectivity of the one or more networks, and the operational failure of the one or more nodes and the one or more runtime nodes deployed in the distributed dataflow model based on implementation of the one or more bridge wires.

10. The computing system of claim 9, wherein the TCP connection established between the one or more runtime nodes comprises initiation of connection by a peer-to-peer publisher of a runtime node and listening for connection request by a peer-to-peer subscriber of another runtime node among the one or more runtime nodes, and initiation of connection by the peer-to-peer subscriber of the runtime node and listening connection request by the peer-to-peer publisher.

11. A method for implementing and managing a distributed data flow model, the AI-based method comprising:
obtaining, by one or more hardware processors, a flow configuration file of a predefined format associated with one or more runtime nodes of a distributed data flow model from a controller, wherein the flow configuration file comprises a JavaScript Object Notation (JSON) file format comprising data flow configuration information, wherein the data flow configuration information comprises flow design of the one or more runtime nodes, one or more node configurations, one or more interconnecting wires, and one or more runtime node configurations, and wherein the one or more runtime nodes are one or more compute nodes equipped with a predetermined functionality for execution of a distributed data flow;
identifying, by the one or more hardware processors, one or more socket roles and a unique identification number corresponding to each of one or more flow neighbors based on the obtained flow configuration file;
establishing, by the one or more hardware processors, a Transmission Control Protocol (TCP) connection of the one or more runtime nodes with each of the one or more flow neighbors based on the identified one or more socket roles and the identified unique identification number, wherein the TCP connection enables TCP keepalives for preventing deactivation of the established TCP connection, and wherein a single TCP connection is established between each pair of flow neighbors from each of the one or more runtime nodes;
establishing, by the one or more hardware processors, a publisher-subscriber relationship of the one or more runtime nodes with each of the one or more flow neighbors for forwarding flow messages based on the established TCP connection, wherein the publisher-subscriber relationship comprises a relationship between a peer-to-peer publisher on a message originating runtime node and a peer-to-peer subscriber on a message receiving runtime node;
implementing, by one or more hardware processors, one or more bridge wires with the one or more runtime nodes and the one or more flow neighbors for implementation of the distributed data flow model based on the established publisher-subscriber relationship;
detecting, by one or more hardware processors, a loss of connectivity of one or more networks, and an operational failure of one or more nodes and the one or more runtime nodes deployed in the distributed dataflow model based on implementation of the one or more bridge wires, wherein the one or more nodes comprise one of: one or more compute nodes and one or more battery powered sensing nodes;
determining, by one or more hardware processors, one or more root causes of the detected loss of connectivity; and
performing, by the one or more hardware processors, one or more operations to attain a predefined level of resiliency of the distributed data flow model over the one or more bridge wires based on the detected loss of connectivity and the determined one or more root causes.

12. The method of claim 11, further comprising:
obtaining distributed data flow details from a user via a controller, wherein the distributed data flow details comprise a design of the distributed data flow model, wherein the controller registers the one or more runtime nodes of the distributed data flow model based on the obtained distributed data flow details from the user, wherein the distributed data flow model comprise a dataflow model distributed over the one or more runtime nodes, and wherein the one or more runtime nodes are one or more runtime nodes;
receiving the data flow configuration information of the one or more runtime nodes from each of the one or more runtime nodes via the controller upon successful registration of the one or more runtime nodes; and
generating the configuration file of the predefined format for the one or more runtime nodes via the controller upon the successful registration.

13. The method of claim 11, wherein identifying the one or more socket roles and the unique identification number corresponding to each of the one or more flow neighbors based on the obtained flow configuration file upon determining the publisher and the subscriber service information comprises:
identifying one or more portions of the distributed data flow network based on the obtained flow configuration file;
deploying one or more nodes and one or more interconnecting wires on the one or more runtime nodes based on the identified one or more portions of one or more distributed dataflows, wherein the one or more nodes are processing blocks in flow-based programming paradigm, wherein the processing blocks are a type of computational circuit comprising at least one of: microprocessor, a microcontroller, a complex instruction set computing microprocessor, a reduced instruction set computing microprocessor, software routine, a function in the list, a very long instruction word microprocessor, an explicitly parallel instruction computing microprocessor, and a digital signal processor, wherein the one or more nodes comprise one or more input ports and one or more output ports, and wherein the one or more interconnecting wires correspond to flow of messages from an output port of a node to an input port of another node;
extracting the data flow configuration information from the flow configuration file for deploying the one or more nodes and the one or more interconnecting wires;
identifying the one or more flow neighbors associated with each of the one or more runtime nodes based on the extracted data flow configuration information, wherein the one or more flow neighbors comprise two runtime nodes that have one or more bridge wires between the two runtime nodes, and wherein the one or more bridge wires are defined as a wire in a flow that crosses runtime node boundaries;
determining publisher-subscriber service information for each of the identified one or more flow neighbors based on the extracted data flow configuration information, wherein the publisher-subscriber service information comprises registration information of a peer-to-peer publisher and a peer-to-peer subscriber with a unique topic between the one or more runtime nodes and the one or more flow neighbors; and
identifying the one or more socket roles and the unique identification number corresponding to each of the one or more flow neighbors based on the obtained flow configuration file upon determining the publisher and the subscriber service information, wherein the one or more socket rules comprise at least one of: an initiate socket role and an accept socket role.

14. The method of claim 11, further comprising:
implementing the one or more bridge wires with the one or more runtime nodes and the one or more flow neighbors in a private network in absence of a firewall;
implementing the one or more bridge wires with the one or more runtime nodes and the one or more flow neighbors in a hybrid network of a public-private network in presence of a firewall; and
implementing the one or more bridge wires with the one or more runtime nodes and the one or more flow neighbors in a hierarchy of networks protected by one or more firewalls.

15. The method of claim 11, wherein the one or more root causes of the detected loss of connectivity comprise a flow neighbor becomes active from one of: an inactive state and a down state, and data channel security keys of the one or more runtime nodes are expired.

16. The method of claim 11, wherein performing the one or more operations to attain the predefined level of resiliency of the distributed data flow model over the one or more bridge wires based on the detected loss of connectivity and the determined one or more root causes comprises:
enabling TCP keepalives by TCP connection utilized by the one or more bridge wires to prevent connections from timing out and getting dropped by one or more network devices upon determining that a flow neighbor becomes active from one of: an inactive state and a down state;
implementing a heartbeat mechanism over the one or more bridge wires to indicate liveliness of the runtime node upon determining that the flow neighbor becomes active from one of: the inactive state and the down state;
reestablishing the TCP connection through one or more socket operations upon determining that the flow neighbor becomes active from one of: the inactive state and the down state, wherein the one or more socket operations comprise an initiate operation, an accept operation, and a listen operation; and
reducing implementation overhead based on automatic reconnection capability of the socket library on runtime node upon determining that the flow neighbor becomes active from one of: the inactive state and the down state.

17. The method of claim 11, performing the one or more operations to attain the predefined level of resiliency of the distributed data flow model over the one or more bridge wires based on the detected loss of connectivity and the determined one or more root causes comprises:
utilizing a separate communication channel for one or more administrative tasks, wherein the one or more administrative tasks comprise a flow file propagation from a controller to a runtime node and a notification of runtime configuration changes from one or more runtime nodes to the controller of the distributed data flow model upon determining that data channel security keys of the one or more runtime nodes are expired;
obtaining separate security key pairs for the one or more runtime nodes upon determining that the data channel security keys of the one or more runtime nodes are expired; and
refreshing a data channel key pair via the one or more runtime nodes one of: periodically and on demand to improve security posture of the distributed data flow model.

18. The method of claim 11, wherein the one or more networks comprise private network, a public network and a hybrid network.

19. The method of claim 11, wherein detecting the loss of connectivity of the one or more networks, and the operational failure of one or more nodes and the one or more runtime nodes deployed in the distributed dataflow model based on implementation of the one or more bridge wires comprises:
identifying the one or more nodes, the one or more interconnecting wires and the one or more runtime nodes deployed in the distributed dataflow model;
identifying a secured TCP connection established between the one or more runtime nodes deployed in the distributed dataflow model for transmission of flow messages;
establishing a peer-to-peer publisher on a message originating runtime node and a peer-to-peer subscriber on a message receiving runtime node based on an identification of the secured TCP connection established between each of the one or more runtime nodes;
implementing the one or more bridge wires with each of the one or more runtime nodes upon identifying a relationship established between the peer-to-peer publisher and the peer-to-peer subscriber between the one or more runtime nodes within the one or more networks; and
detecting the loss of connectivity of the one or more networks, and the operational failure of the one or more nodes and the one or more runtime nodes deployed in the distributed dataflow model based on implementation of the one or more bridge wires.

20. The method of claim 19, wherein the TCP connection established between the one or more runtime nodes comprises initiation of connection by a peer-to-peer publisher of a runtime node and listening for connection request by a peer-to-peer subscriber of another runtime node among the one or more runtime nodes, and initiation of connection by the peer-to-peer subscriber of the runtime node and listening connection request by the peer-to-peer publisher.
